(19) United States
(12) Patent Application Publication
(10) Pub. No.: US 2026/0024489 A1
(43) Pub. Date: Jan. 22, 2026

(54) DISPLAY DEVICE, METHOD OF DRIVING THE SAME, AND ELECTRONIC DEVICE

(71) Applicant: Samsung Display Co., Ltd., Yongin-si (KR)

(72) Inventors: Nam Jae LIM, Yongin-si (KR); Jong Man KIM, Yongin-si (KR); Seung Ho PARK, Yongin-si (KR); Byoung Kwan AN, Yongin-si (KR); Sang Myeon HAN, Yongin-si (KR)

(21) Appl. No.: 19/225,875

(22) Filed: Jun. 2, 2025

(30) Foreign Application Priority Data
Jul. 18, 2024 (KR) 10-2024-0094834

(51) Int. Cl. G09G 3/32; G09G 3/3233

(52) U.S. Cl. CPC G09G 3/32; G09G 3/3233; G09G 2300/0842; G09G 2310/08; G09G 2320/0233; G09G 2320/0285

(57) ABSTRACT

A display device includes: a display unit including pixels; a deterioration compensator configured to generate input deterioration data by reflecting weights on input data and configured to generate correction data using accumulated deterioration data generated by accumulating the input deterioration data; and a timing controller configured to generate output data by reflecting the correction data to the input data, wherein the weights include an efficiency weight, and the efficiency weight corresponds to efficiency of the pixels corresponding to each of grayscales.

### CROSS-REFERENCE TO RELATED APPLICATION

The present application claims priority to and the benefit of Korean Patent Application No. 10-2024-0094834, filed on Jul. 18, 2024, in the Korean Intellectual Property Office, the entire disclosure of which is incorporated herein by reference.

### BACKGROUND

### 1. Field

Aspects of some embodiments of the present disclosure relate to a display device, a method of driving the same, and an electronic device.

### 2. Description of the Related Art

A display device includes a data driver and a display panel, and the display panel includes pixels. The data driver provides a data signal to the pixels through data lines. Each of the pixels includes a driving transistor and a light emitting element. The driving transistor controls the amount of current flowing through the pixel based on the data signal, and the light emitting element emits light with a luminance corresponding to the amount of current.

As the driving time of the display panel increases, the light emitting element and the driving transistor may deteriorate. As an example, as the driving time increases, the light emitting element may generate light with low luminance in response to the same data signal. As an example, as the driving time increases, a threshold voltage of the driving transistor may vary (or shift). Due to the deterioration of the light emitting element and the driving transistor, the pixel may emit light with a luminance different from the desired luminance.

A method has been proposed to compensate for the deterioration of the light emitting element and the driving transistor by accumulating data so that the pixel emits light with the desired luminance. However, accurate compensation may not be achieved because the efficiency corresponding to a grayscale of data is not reflected.

The above information disclosed in this Background section is only for enhancement of understanding of the background and therefore the information discussed in this Background section does not necessarily constitute prior art.

### SUMMARY

Aspects of some embodiments of the present invention include a display device, a method of driving the same, and an electronic device capable of relatively improving the accuracy of deterioration compensation.

A display device according to some embodiments of the present invention may include a display unit including pixels; a deterioration compensator generating input deterioration data by reflecting weights on input data and generating correction data using accumulated deterioration data generated by accumulating the input deterioration data; and a timing controller generating output data by reflecting the correction data to the input data. The weights may include an efficiency weight, and the efficiency weight may correspond to efficiency of the pixels corresponding to each of grayscales.

According to some embodiments, the efficiency weight may be set so that a difference in driving current flowing through each of the pixels corresponding to each of the grayscales is reflected in the input deterioration data.

According to some embodiments, the efficiency weight may be stored in the deterioration compensator in units of pixels corresponding to each of the grayscales.

According to some embodiments, the efficiency weight may be stored in the deterioration compensator in units of blocks corresponding to each of the grayscales, and each of the blocks may include at least two pixels.

According to some embodiments, the efficiency weight may be stored in the deterioration compensator by averaging the efficiency weight of each of the pixels corresponding to each of the grayscales.

According to some embodiments, the weights may further include a position weight corresponding to positions of the pixels and a temperature weight corresponding to a temperature.

According to some embodiments, the display device may further include a memory in which the accumulated deterioration data is stored.

According to some embodiments, the deterioration compensator may include an efficiency lookup table in which the efficiency weight is stored; a position lookup table in which the position weight is stored; a temperature lookup table in which the temperature weight is stored; a deterioration accumulator generating the input deterioration data by reflecting the efficiency weight, the position weight, and the temperature weight to the input data, accumulating the input deterioration data, and storing the accumulated deterioration data in the memory; and a data generator generating the correction data using the accumulated deterioration data stored in the memory.

According to some embodiments, the efficiency lookup table, the position lookup table, and the temperature lookup table may be stored in the memory.

According to some embodiments, the display device may further include a scan driver driving scan lines connected to the pixels; and a data driver driving data lines connected to the pixels. The data driver may generate a data signal using the output data, and supply the data signal to the pixels via the data lines.

A method of driving a display device according to some embodiments of the present invention may include generating input deterioration data by reflecting an efficiency weight corresponding to efficiency of pixels corresponding to each of grayscales to input data; generating accumulated deterioration data by accumulating the input deterioration data; generating correction data based on the accumulated deterioration data so that deterioration of the pixels can be compensated for; and generating output data by reflecting the correction data to the input data.

According to some embodiments, the efficiency weight may be set so that a difference in driving current flowing through each of the pixels corresponding to each of the grayscales is reflected in the input deterioration data.

According to some embodiments, the efficiency weight may be reflected in the input data in units of pixels corresponding to each of the grayscales.

According to some embodiments, the efficiency weight may be reflected in the input data in units of blocks corresponding to each of the grayscales, and each of the blocks may include at least two pixels.

According to some embodiments, in the generating the input deterioration data, a position weight corresponding to positions of the pixels and a temperature weight corresponding to a temperature may be further reflected in the input data.

According to some embodiments, the method of driving the display device may further include generating a data signal using the output data; and supplying the data signal to the pixels.

An electronic device according to some embodiments of the present invention may include a display panel including pixels; a data conversion circuit generating input deterioration data by reflecting weights on input data and generating correction data using accumulated deterioration data generated by accumulating the input deterioration data; and a controller generating output data by reflecting the correction data to the input data. The weights may include an efficiency weight, and the efficiency weight may reflect efficiency of the pixels corresponding to each of grayscales.

According to some embodiments, the efficiency weight may be set so that a difference in driving current flowing through each of the pixels corresponding to each of the grayscales is reflected in the input deterioration data.

According to some embodiments, the efficiency weight may be stored in the data conversion circuit in units of pixels corresponding to each of the grayscales.

According to some embodiments, the efficiency weight may be stored in the data conversion circuit in units of blocks corresponding to each of the grayscales, and each of the blocks may include at least two pixels.

Aspects of some embodiments of the present invention are not limited to the characteristics mentioned above, and other technical objects not mentioned will be clearly understood by those skilled in the art from the description below.

### BRIEF DESCRIPTION OF THE DRAWINGS

The accompanying drawings, which are included to provide a further understanding of the inventive concepts, and are incorporated in and constitute a part of this specification, illustrate aspects of some embodiments of the present disclosure, and, together with the description, serve to explain aspects of some embodiments of the present disclosure.

FIG. 1 is a diagram illustrating a display device according to some embodiments of the present invention.

FIGS. 2A and 2B are diagrams for explaining efficiency corresponding to a grayscale.

FIG. 3 is a graph illustrating luminance, current, and efficiency corresponding to a grayscale.

FIGS. 4 and 5 are diagrams illustrating aspects of a display unit according to some embodiments.

FIG. 6 is a diagram illustrating aspects of a deterioration compensator shown in FIG. 1 according to some embodiments.

FIG. 7 is a diagram illustrating aspects of a method of driving a display device according to some embodiments of the present invention.

FIG. 8 is a diagram illustrating aspects of a pixel shown in FIG. 1 according to some embodiments.

FIG. 9 is a diagram for explaining an example of a method of driving the pixel shown in FIG. 8.

FIG. 10 is a diagram illustrating an electronic device according to some embodiments of the present invention.

### DETAILED DESCRIPTION

Hereinafter, various embodiments of the present invention will be described in detail with reference to the accompanying drawings so that those of ordinary skill in the art may easily implement the present invention. The present invention may be embodied in various different forms and is not limited to the embodiments described herein.

In order to clearly describe the present invention, parts that are not related to the description are omitted, and the same or similar components are denoted by the same reference numerals throughout the specification. Therefore, the reference numerals described above may also be used in other drawings.

In addition, in the description, the expression “is the same” may mean “substantially the same”. That is, it may be the same enough to convince those of ordinary skill in the art to be the same. In other expressions, “substantially” may be omitted.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, and may optionally be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the inventive concept. In addition, in some embodiments, the block, unit and/or module may be physically combined into more complex blocks, units, and/or modules without departing from the scope of the inventive concept.

The term “connection” between two components may mean that both of an electrical connection and a physical connection are used inclusively, but the present invention is not limited thereto. For example, “connection” used based on a circuit diagram may mean an electrical connection, and “connection” used based on a cross-sectional view and a plan view may mean a physical connection.

Although a first, a second, and the like are used to describe various components, these components are not limited by these terms. These terms are used only to distinguish one component from another component. Therefore, a first component described below may be a second component within the technical spirit of the present invention.

Meanwhile, the present invention is not limited to the embodiments disclosed below, and may be modified in various forms and may be implemented. In addition, each of the embodiments disclosed below may be implemented alone or in combination with at least one of other embodiments.

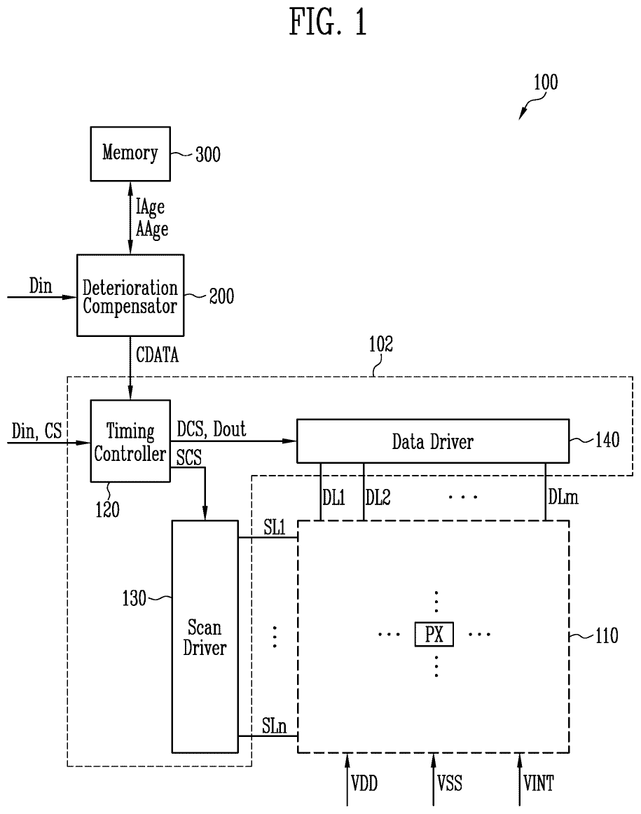

FIG. 1 is a diagram illustrating a display device according to some embodiments of the present invention.

Referring to FIG. 1, a display device 100 according to some embodiments of the present invention may include a display unit 110 (or a display panel), a panel driver 102, a deterioration compensator 200, and a memory 300.

The display device 100 may be applied to electronic devices such as a computer, a laptop, a cellular phone, a smart phone, a personal digital assistants (PDA), a portable multimedia player (PMP), a digital TV, a digital camera, a portable game console, a navigation device, a wearable device, an loT (internet of things) device, an loE (internet of everything) device, an e-book, a VR (virtual reality) device, an AR (augmented reality) device, a vehicle navigation system, a video phone, a surveillance system, an auto focus system, a tracking system, a motion detection system, and the like.

The display unit 110 may include pixels PX formed in areas defined by scan lines SL1 to SLn and data lines DL1, DL2, . . . , and DLm, where n and m may be natural numbers greater than or equal to 3. Each of the pixels PX may include a driving transistor and a light emitting element.

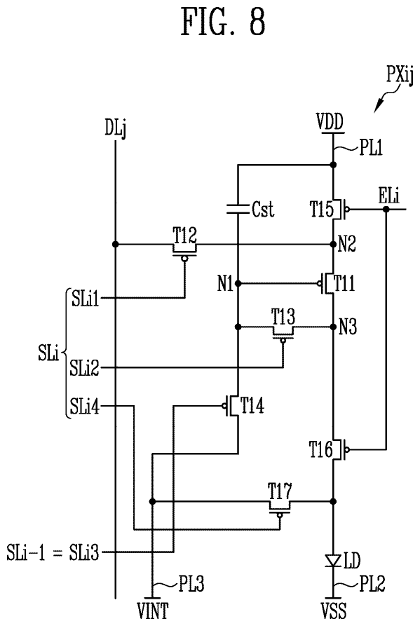

As an example, a pixel PXij (see FIG. 8) located on an i-th horizontal line (or pixel row) and a j-th vertical line (or pixel column) may be connected to an i-th scan line SLi and a j-th data line DLj, where i may be a natural number equal to or less than n, and j may be a natural number equal to or less than m. The pixels PX may be selected in units of horizontal lines (for example, pixels PX connected to the same scan line may be classified into one horizontal line (or pixel row)) when a scan signal is supplied to the scan lines SL1 to SLn, and the pixels PX selected by the scan signal may receive a data signal from a data line (any one of DL1 to DLm) connected thereto.

The driving transistor included in each of the pixels PX may control the amount of current supplied to the light emitting element in response to the data signal, and the light emitting element may emit light with a luminance corresponding to the amount of current.

According to some embodiments, each of the pixels PX may be sub-pixels. Each of the sub-pixels may emit light of one of the colors red, green, and blue. However, this is only an example, and each of the sub-pixels may also emit light of colors such as cyan, magenta, or yellow.

According to some embodiments, the panel driver 102 may include a timing controller 120, a scan driver 130, and a data driver 140. Components included in the panel driver 102 may be implemented as separate integrated circuits, and two or more of the above-described components may be implemented by being integrated into one integrated circuit. In addition, the scan driver 130 may be formed in the display unit 110.

The scan driver 130 may receive a scan driving signal SCS from the timing controller 120. The scan driving signal SCS may include at least one scan start signal and clock signals required to drive the scan driver 130. The scan driver 130 may generate the scan signal by shifting the scan start signal in response to a clock signal.

The scan driver 130 may include a plurality of scan drivers so that the scan signal may be supplied at different timings within the same horizontal period in response to a circuit structure of the pixels PX.

The data driver 140 may receive output data Dout and a data driving signal DCS from the timing controller 120. The data driving signal DCS may include a sampling signal and/or timing signals required to drive the data driver 140. The data driver 140 may generate an analog data signal based on the data driving signal DCS and the output data Dout. The data driver 140 may supply the data signal in units of 1 horizontal period.

The timing controller 120 may receive input data Din and a control signal CS from a host system through an interface. As an example, the timing controller 120 may receive the input data Din and the control signal CS from at least one of a graphics processing unit (GPU), a central processing unit (CPU), or an application processor (AP) included in the host system. The control signal CS may include various signals including a clock signal.

The timing controller 120 may generate the scan driving signal SCS and the data driving signal DCS based on the control signal CS. The scan driving signal SCS and the data driving signal DCS may be supplied to the scan driver 130 and the data driver 140, respectively.

The timing controller 120 may generate the output data Dout by reflecting correction data CDATA to the input data Din. Here, the correction data CDATA may be set so that deterioration of the light emitting element and the driving transistor included in each of the pixels PX is compensated for. The output data Dout may be provided to the data driver 140.

According to some embodiments, the panel driver 102 may further include a power supply unit that generates a first driving power source VDD, a second driving power source VSS, and an initialization power source VINT for driving the display unit 110.

The deterioration compensator 200 may generate input deterioration data IAge based on the input data Din and generate accumulated deterioration data AAge by accumulating the input deterioration data IAge. As an example, the deterioration compensator 200 may accumulate the input deterioration data IAge and store it in the memory 300. In this case, the accumulated deterioration data AAge may be stored in the memory 300.

When the input data Din is input, the deterioration compensator 200 may generate the input deterioration data IAge by reflecting a position weight corresponding to the position of a pixel PX to which the input data Din is supplied, a temperature weight corresponding to the temperature of the display device 100, and an efficiency weight corresponding to a grayscale of the input data Din. The deterioration compensator 200 may additionally reflect various known weights, such as a frequency at which the display device 100 is driven, a light emitting time, and the like to the input deterioration data IAge.

The deterioration compensator 200 may generate the accumulated deterioration data AAge by accumulating the input deterioration data IAge corresponding to the position of a pixel PX or the position of a block in which the pixel PX is included. The accumulated deterioration data AAge may include deterioration information for each of the pixels PX. The deterioration compensator 200 may generate the correction data CDATA corresponding to each of the pixels PX (or block unit) in response to the accumulated deterioration data AAge and supply the correction data CDATA to the timing controller 120. The correction data CDATA may have a correction value (e.g., a set or predetermined correction value) by which the deterioration of the pixel PX can be compensated for. The timing controller 120 may generate the output data Dout by reflecting the correction data CDATA to the input data Din so that deterioration of each of the pixels PX can be compensated for.

The memory 300 may store the accumulated deterioration data AAge. The memory 300 may supply the accumulated deterioration data AAge to the deterioration compensator 200 in response to the control of the deterioration compensator 200.

According to some embodiments, the deterioration compensator 200 may be implemented as a separate application processor (AP). According to some embodiments, at least a portion or the entire configuration of the deterioration compensator 200 may be included in the timing controller 120. According to some embodiments, the deterioration compensator 200 may be included in an IC that includes the data driver 140.

Additionally, although some embodiments in which the input deterioration data IAge is generated based on the input data Din has been described with reference to FIG. 1, embodiments of the present invention are not limited thereto. As an example, the deterioration compensator 200 may also generate the input deterioration data IAge based on the output data Dout.

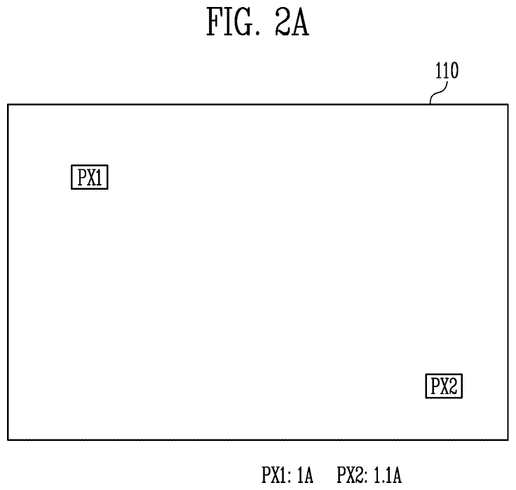

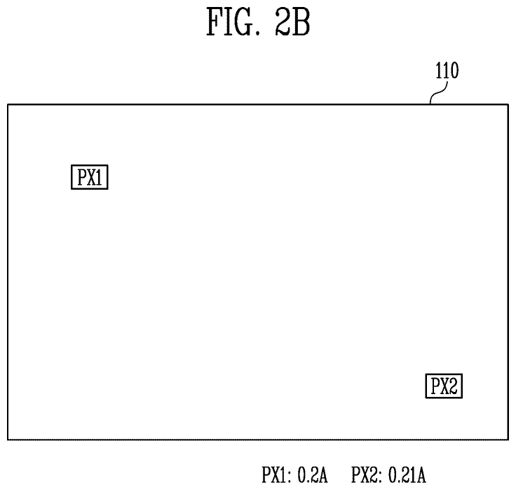

FIGS. 2A and 2B are diagrams for explaining efficiency corresponding to a grayscale. A first pixel PX1 and a second pixel PX2 shown in FIGS. 2A and 2B are included in the display unit 110 and represent pixels formed at different positions.

Referring to FIG. 2A, the efficiency may differ depending on the positions of the pixels PX1 and PX2. As an example, when a data signal corresponding to 255 grayscale Gray is input to the first pixel PX1, the driving transistor may supply a driving current of 1 A to the light emitting element LD. Accordingly, the luminance (for example, 1000 nit) corresponding to 255 grayscale Gray may be implemented in the first pixel PX1. As an example, when a data signal corresponding to 255 grayscale

Gray is input to the second pixel PX2, the driving transistor may supply a driving current of 1.1 A to the light emitting element LD. Accordingly, the luminance (for example, 1000 nit) corresponding to 255 grayscale Gray may be implemented in the second pixel PX2.

When implementing the same grayscale, if driving currents in the pixels PX1 and PX2 are different, the difference in the driving currents must be reflected in the input deterioration data IAge (and/or the accumulated deterioration data AAge). According to some embodiments, the driving current (for example, 1 A or 1.1 A) flowing when the pixels PX1 and PX2 emit light at a maximum luminance may be measured, and a weighting may be reflected corresponding to the measurement result. As an example, by setting the position weight corresponding to the positions of the pixels PX1 and PX2 and generating the input deterioration data IAge by reflecting the position weight, the degree of deterioration corresponding to the difference in driving current may be reflected in the accumulated deterioration data AAge. As an example, the first pixel PX1 and the second pixel PX2 may have an efficiency difference of 10%, and this efficiency difference may be set as the position weight.

However, when generating the input deterioration data IAge (and/or the accumulated deterioration data AAge) using only the position weight, the efficiency of the pixels PX1 and PX2 corresponding to a grayscale may not be reflected.

Referring to FIG. 2B, when a data signal corresponding to 123 grayscale Gray is input to the first pixel PX1, the driving transistor may supply a driving current of 0.2 A to the light emitting element LD. Accordingly, the luminance (for example, 200 nit) corresponding to 123 grayscale Gray may be implemented in the first pixel PX1. In addition, when a data signal corresponding to 123 grayscale Gray is input to the second pixel PX2, the driving transistor may supply a driving current of 0.21 A to the light emitting element LD. Accordingly, the luminance (for example, 200 nit) corresponding to 123 grayscale Gray may be implemented in the second pixel PX2.

That is, when the first pixel PX1 and the second pixel PX2 implement 255 grayscale, there may be an efficiency difference of 10%, and when the first pixel PX1 and the second pixel PX2 implement 123 grayscale, there may be an efficiency difference of 5%.

To compensate for this, according to some embodiments of the present invention, by reflecting an efficiency weight corresponding to each of grayscales to the input data Din, the input deterioration data IAge and corresponding accumulated deterioration data Aage may be generated. In this case, the efficiency difference of the pixels PX1 and PX2 corresponding to each grayscale may be reflected in the accumulated deterioration data AAge, and thus the accuracy of deterioration compensation can be relatively improved.

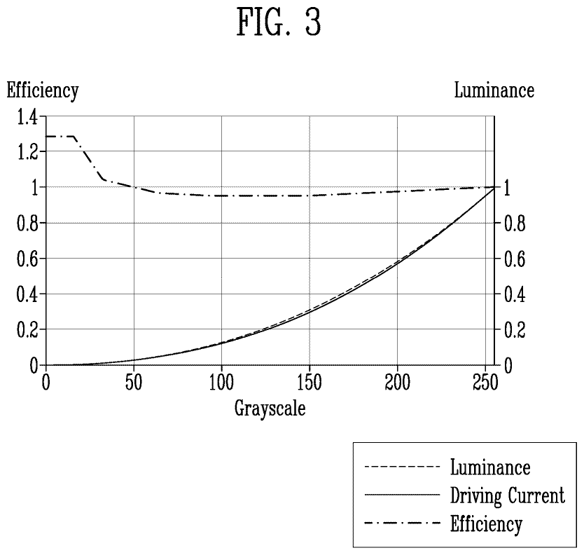

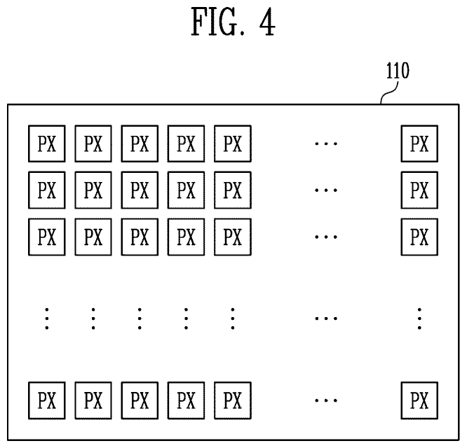

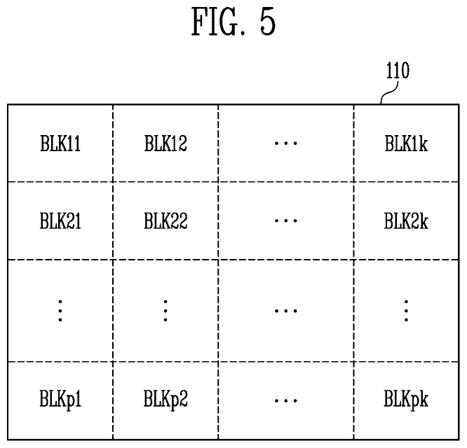

FIG. 3 is a graph illustrating luminance, current, and efficiency corresponding to a grayscale. FIGS. 4 and 5 are diagrams illustrating aspects of a display unit according to some embodiments.

In FIG. 3, the left side of the Y-axis represents efficiency, and the right side of the Y-axis represents luminance when a maximum luminance is set to “1”. In addition, the X-axis in FIG. 3 may represent grayscale.

Referring to FIG. 3, the luminance of a pixel PX may increase in response to an increase in the grayscale, and the driving current may increase in response to an increase in the luminance of the pixel PX. Here, the efficiency (or light emitting efficiency) of the pixel PX may be set differently for each of grayscales. As an example, below approximately 50 grayscale, the efficiency of the pixel PX may have a value higher than “1”, and above approximately 50 grayscale, the efficiency of the pixel PX may have a value lower than or equal to “1”. Here, the efficiency may correspond to luminance/current.

The pixel PX may have different efficiencies corresponding to each grayscale. In response to this, the efficiency corresponding to each grayscale must be reflected in the input deterioration data IAge (and/or the accumulated deterioration data AAge) so that the deterioration of the pixel PX can be stably compensated. The efficiency of the pixel PX corresponding to each grayscale can be measured during a manufacturing process.

According to some embodiments, as shown in FIG. 4, the driving current of pixels PX corresponding to each of grayscales (for example, 0 to 255 grayscales) may be measured in a manufacturing process, and the efficiency weight may be generated based on the driving current flowing through each of the pixels PX corresponding to each grayscale. Here, the efficiency weight may be set so that the difference in driving current flowing through each of the pixels PX corresponding to the grayscale is reflected in the input deterioration data IAge.

As an example, among the pixels PX, a pixel (e.g., a set or predetermined pixel) may be set as a reference pixel, and based on the reference pixel, a difference in driving current of each of the pixels PX at the same grayscale may be stored in the deterioration compensator 200 as the efficiency weight. Here, the efficiency weight may be stored in the deterioration compensator 200 corresponding to each grayscale. In addition, the efficiency weight may be stored for each grayscale of each of the pixels PX (or in units of pixels PX). However, when the efficiency weight is stored in the deterioration compensator 200 corresponding to each grayscale in units of pixels PX, there may be concerns that the memory capacity will increase.

According to some embodiments, as shown in FIG. 5, the display unit 110 may be divided into a plurality of blocks BLK11, BLK12, . . . , and BLK1k, BLK21, BLK22, . . . , and BLK2k, and BLKp1, BLKp2, . . . , and BLKpk, where k and p may be natural numbers greater than or equal to 3. Each of the blocks BLK11 to BLKpk may have at least two pixels PX. The efficiency weight may be stored in the deterioration compensator 200 in units of blocks BLK11 to BLKpk. As an example, efficiency weight information corresponding to each grayscale may be stored in the deterioration compensator 200 in units of blocks BLK11 to BLKpk.

As an example, the efficiency difference corresponding to a first grayscale of pixels PX included in a first block BLK11 may be averaged and stored in the deterioration compensator 200 as the efficiency weight of the first block BLK11 corresponding to the first grayscale. In addition, the efficiency difference corresponding to a second grayscale of the pixels PX included in the first block BLK11 may be averaged and stored in the deterioration compensator 200 as the efficiency weight of the first block BLK11 corresponding to the second grayscale. In the same way, the efficiency weight corresponding to each grayscale may be stored in the deterioration compensator 200 in units of blocks BLK11 to BLKpk.

According to some embodiments, the efficiency weight may be stored in the deterioration compensator 200 in units of display units 110. As an example, the efficiency weight of each of the pixels PX corresponding to each grayscale may be averaged and stored in the deterioration compensator 200 as the efficiency weight. In this case, a deviation corresponding to the position of each of the pixels PX may be compensated for by position weight information.

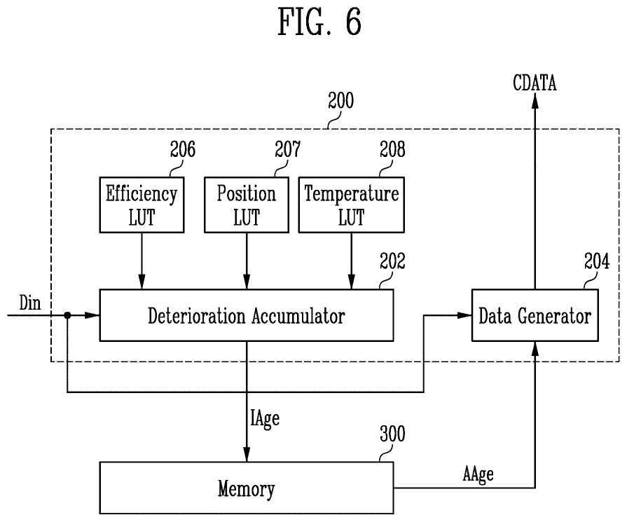

FIG. 6 is a diagram illustrating aspects of a deterioration compensator shown in FIG. 1 according to some embodiments.

Referring to FIG. 6, the deterioration compensator 200 may include look-up tables (LUT) 206, 207, and 208, a deterioration accumulator 202, and a data generator 204. The look-up tables (LUT) 206, 207, and 208 may be stored in the memory 300.

The look-up tables 206, 207, and 208 may include an efficiency LUT 206, a position LUT 207, and a temperature LUT 208. The efficiency LUT 206 may include efficiency weights of the pixels PX corresponding to each grayscale. Here, the efficiency weights may be stored in units of display units 110, blocks BLK11 to BLKpk, or pixels PX.

The position LUT 207 may store position weights corresponding to the positions of pixels PX. The driving current flowing through each pixel PX may be set differently corresponding to the positions of the pixels PX. The position weights may be set so that a deviation of the driving current corresponding to the positions of the pixels PX is reflected in the input deterioration data IAge (and/or the accumulated deterioration data AAge).

The temperature LUT 208 may store temperature weights corresponding to temperature. The driving current flowing through each pixel PX may be set differently corresponding to the temperature. The temperature weights may be set so that a deviation of the driving current corresponding to the temperature is reflected in the input deterioration data IAge (and/or the accumulated deterioration data AAge).

The deterioration accumulator 202 may generate the input deterioration data IAge by reflecting the position weight, the temperature weight, and the efficiency weight to the input data Din. As an example, the deterioration accumulator 202 may generate the input deterioration data IAge by reflecting the position weight corresponding to the position of a pixel PX (for example, a specific pixel) to which the input data Din is supplied, the efficiency weight corresponding to the grayscale of the input data Din supplied to the specific pixel, and the temperature weight corresponding to an operating temperature of the display device 100.

Additionally, the deterioration accumulator 202 may generate the input deterioration data IAge by additionally reflecting various known weights, for example, on-duty (or light emitting time) of pixels PX, driving frequency, and the like.

The input deterioration data IAge generated in the deterioration accumulator 202 may be supplied to the memory 300. The input deterioration data IAge may be accumulated in response to the position of a pixel PX or the position of a block in which the pixel PX is included. Accordingly, the accumulated deterioration data AAge may be stored in the memory 300.

The data generator 204 may receive the input data Din and load the accumulated deterioration data AAge corresponding to the input data Din. In addition, the data generator 204 may generate the correction data CDATA corresponding to each pixel PX (or block) in response to the accumulated deterioration data AAge and supply the correction data CDATA to the timing controller 120.

According to the above-described embodiments of the present invention, efficiency information of the pixels PX corresponding to each grayscale may be reflected in the accumulated deterioration data Aage. Accordingly, the deterioration of the pixels PX can be stably compensated.

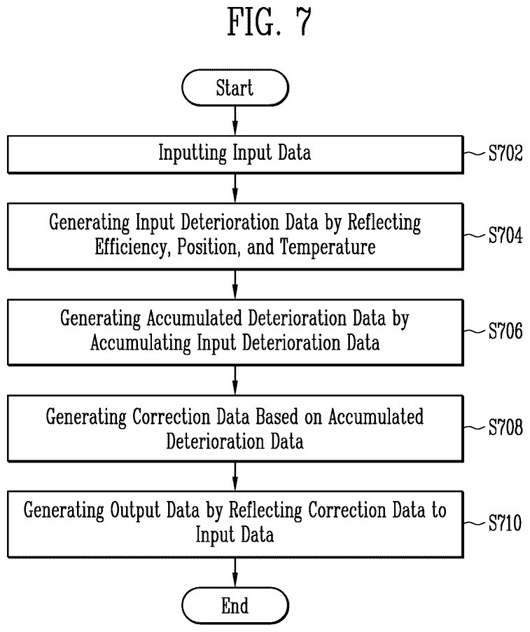

FIG. 7 is a diagram illustrating aspects of a method of driving a display device according to some embodiments of the present invention. Although FIG. 7 illustrates various operations in a method of driving a display device, embodiments according to the present disclosure are not limited thereto, and according to various embodiments, the method may include additional operations, or fewer operations, or the order of operations may vary, unless otherwise stated or implied, without departing from the spirit and scope of embodiments according to the present disclosure.

Referring to FIGS. 6 and 7, first, input data Din may be input to the deterioration accumulator 202 (S702). When the input data Din is input, the deterioration accumulator 202 may generate input deterioration data IAge by reflecting an efficiency weight, a position weight, and a temperature weight to the input data Din (S704). In addition, the input deterioration data IAge may be accumulated in the memory 300 in units of pixels PX or blocks, thereby generating accumulated deterioration data AAge (S706).

The data generator 204 may generate correction data CDATA based on the accumulated deterioration data AAge (S708). Here, the correction data CDATA may be generated so that deterioration of the pixels PX is corrected. The timing controller 120 may generate output data Dout by reflecting the correction data CDATA to the input data Din (S710).

The data driver 140 may generate a data signal using the output data Dout and supply the data signal to the pixels PX. Here, the correction data CDATA may be reflected in the data signal, and accordingly, an image with uniform luminance can be displayed on the display unit 110 in response to the same data signal regardless of the deterioration of the pixels PX.

FIG. 8 is a diagram illustrating aspects of a pixel shown in FIG. 1 according to some embodiments. Although FIG. 8 illustrates various components in a pixel according to some embodiments of the present disclosure, embodiments are not limited thereto, and according to some embodiments, the pixel may include additional components or fewer components, without departing from the spirit and scope of embodiments according to the present disclosure.

Referring to FIG. 8, a pixel PXij according to some embodiments of the present invention may include transistors T11, T12, T13, T14, T15, T16, and T17, a storage capacitor Cst, and a light emitting element LD.

Hereinafter, a circuit composed of P-type transistors is described as an example. However, those skilled in the art will be able to design a circuit composed of N-type transistors by changing the polarity of the voltage applied to a gate terminal. Similarly, one skilled in the art will be able to design a circuit composed of a combination of P-type transistors and N-type transistors. The transistors may be configured in various types, such as thin film transistors (TFTs), field effect transistors (FETs), and bipolar junction transistors (BJTs).

An eleventh transistor T11 may have a gate electrode connected to a first node N1, a first electrode connected to a second node N2, and a second electrode connected to a third node N3. The eleventh transistor T11 may be referred to as a driving transistor.

A twelfth transistor T12 may have a gate electrode connected to a scan line SLi1, a first electrode connected to a data line DLj, and a second electrode connected to the second node N2. A thirteenth transistor T13 may have a gate electrode connected to a scan line SLi2, a first electrode connected to the first node N1, and a second electrode connected to the third node N3.

A fourteenth transistor T14 may have a gate electrode connected to a scan line SLi3, a first electrode connected to the first node N1, and a second electrode connected to a third power source line PL3. A fifteenth transistor T15 may have a gate electrode connected to an emission control line ELi, a first electrode connected to a first power source line PL1, and a second electrode connected to the second node N2.

A sixteenth transistor T16 may have a gate electrode connected to the emission control line ELi, a first electrode connected to the third node N3, and a second electrode connected to an anode of the light emitting element LD. According to some embodiments, the fifteenth transistor T15 and the sixteenth transistor T16 may be connected to different emission control lines.

A seventeenth transistor T17 may have a gate electrode connected to a scan line SLi4, a first electrode connected to the third power source line PL3, and a second electrode connected to the anode of the light emitting element LD. A first electrode of the storage capacitor Cst may be connected to the first power source line PL1, and a second electrode of the storage capacitor Cst may be connected to the first node N1.

The light emitting element LD may have the anode connected to the second electrode of the sixteenth transistor T16 and a cathode connected to a second power source line PL2. The light emitting element LD may be a light emitting diode. The light emitting element LD may be composed of an organic light emitting diode, an inorganic light emitting diode, a quantum dot/well light emitting diode, or the like. The light emitting element LD may emit light of one of a first color, a second color, and a third color. In addition, according to some embodiments, only one light emitting element LD is provided in each pixel, but according to some embodiments, a plurality of light emitting elements may be provided in each pixel. In this case, the plurality of light emitting elements may be connected in series, in parallel, or in series and parallel.

A voltage of the first driving power source VDD may be applied to the first power source line PL1, a voltage of the second driving power source VSS may be applied to the second power source line PL2, and a voltage of the initialization power source VINT may be applied to the third power source line PL3. For example, the voltage of the initialization power source VINT may be equal to or greater than the voltage of the second driving power source VSS. For example, the voltage of the initialization power source VINT may be equal to or less than a data voltage having the smallest magnitude among voltages of data signals that can be provided.

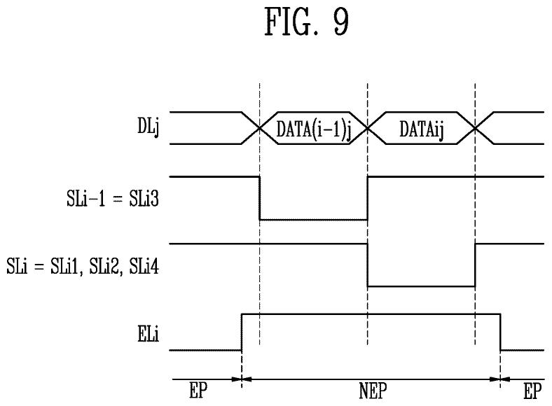

FIG. 9 is a diagram for explaining an example of a method of driving the pixel shown in FIG. 8.

Hereinafter, for convenience of description, it is assumed that the scan lines SLi1, SLi2, and SLi4 are an i-th scan line SLi and the scan line SLi3 is an (i-1)th scan line SLi-1. However, the connection relationship of the scan lines SLi1, SLi2, SLi3, and SLi4 may vary depending on embodiments. For example, the scan line SLi4 may be the (i-1)th scan line or an (i+1)th scan line.

First, an emission signal of a turn-off level (logic high level) may be applied to an i-th emission control line ELi, a data signal DATA (i-1)j for an (i-1)th pixel may be applied to the data line DLj, and a scan signal of a turn-on level (logic low level) may be applied to the scan line SLi3. The high/low of the logic level may vary depending on whether the transistor is P-type or N-type.

In this case, since a scan signal of a turn-off level is applied to the scan lines SLi1 and SLi2, the twelfth transistor T12 may be in a turned-off state, and the data signal DATA (i-1)j for the (i-1)th pixel may be prevented from being input to the pixel PXij.

In this case, since the fourteenth transistor T14 is in a turned-on state, the first node N1 may be connected to the third power source line PL3, and the first node N1 may be initialized with the voltage of the initialization power source VINT. Since an emission control signal of a turn-off level is applied to the emission control line ELi, the transistors T15 and T16 may be in a turned-off state, and unnecessary light emitting of the light emitting element LD due to the process of applying the voltage of the initialization power source can be prevented or reduced.

Next, a data signal DATAij for an i-th pixel PXij may be applied to the data line DLj, and a scan signal of the turn-on level may be applied to the scan lines SLi1 and SLi2. Accordingly, the transistors T12, T11, and T13 may be in a turned-on state, and the data line DLj and the first node N1 may be electrically connected to each other. Accordingly, a compensation voltage obtained by subtracting a threshold voltage of the eleventh transistor T11 from the data signal DATAij may be applied to the second electrode (that is, the first node N1) of the storage capacitor Cst, and the storage capacitor Cst may maintain a voltage corresponding to a difference between the first driving power source VDD and the compensation voltage. This period may be referred to as a threshold voltage compensation period or a data writing period.

In addition, when the scan line SLi4 is the i-th scan line, since the seventeenth transistor T17 is in a turned-on state, the anode of the light emitting element LD and the third power source line PL3 may be connected to each other, and the light emitting element LD may be initialized with a charge amount corresponding to a difference between the voltage of the initialization power source VINT and voltage of the second driving power source VSS.

Thereafter, as an emission control signal of a turn-on level is applied to the i-th emission control line ELi, the transistors T15 and T16 may in a turned-on state. Accordingly, a driving current path connecting the first power source line PL1, the fifteenth transistor T15, the eleventh transistor T11, the sixteenth transistor T16, the light emitting element LD, and the second power source line PL2 may be formed.

The amount of driving current flowing through the first electrode and the second electrode of the eleventh transistor T11 may be controlled according to the voltage maintained in the storage capacitor Cst. The light emitting element LD may emit light with a luminance corresponding to the amount of driving current. The light emitting element LD may emit light until an emission control signal of the turn-off level is applied to the emission control line ELi.

When the emission control signal is at the turn-on level, pixels receiving the emission control signal may be in a display state. Therefore, a period during which the emission control signal is at the turn-on level may be referred to as an emission period

EP (or emission allowance period). In addition, when the emission control signal is at the turn-off level, pixels receiving the emission control signal may be in a non-display state. Therefore, a period during which the emission control signal is at the turn-off level may be referred to as a non-emission period NEP (or emission non-allowance period).

The non-emission period NEP described with reference to FIG. 9 may be a period for preventing or reducing instances of the pixel PXij emitting light at an undesired luminance during the initialization period and the data writing period.

While the data signal written to the pixel PXij is maintained (for example, one frame period), one or more additional non-emission periods NEP may be provided.

This may be to effectively express low-grayscale by reducing the emission period EP of the pixel PXij or to smoothly blur the motion of the image.

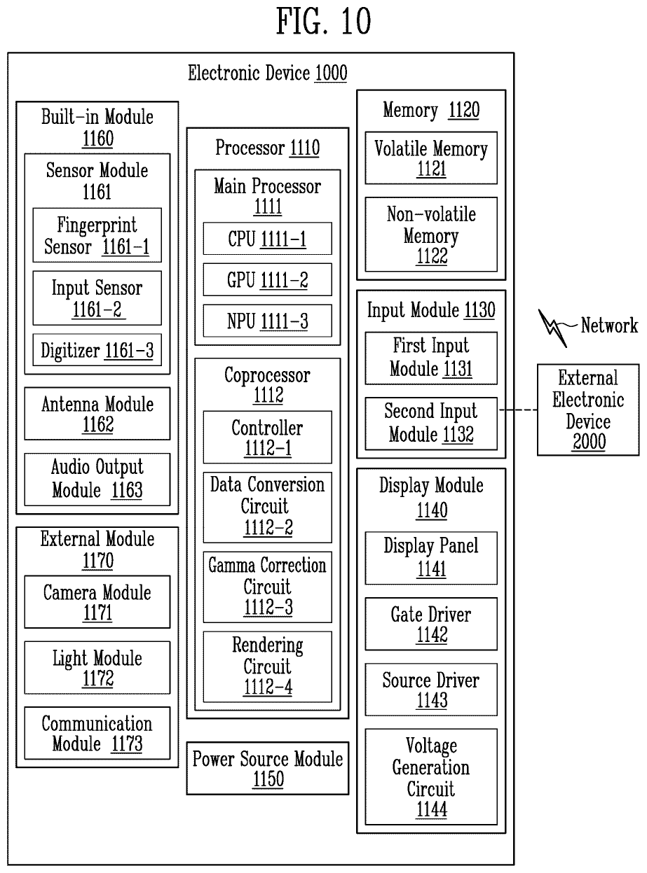

FIG. 10 is a diagram illustrating an electronic device according to some embodiments of the present invention.

Referring to FIG. 10, an electronic device 1000 according to some embodiments of the present invention may output various information through a display module 1140. When a processor 1110 executes an application stored in a memory 1120, the display module 1140 may provide application information to a user through a display panel 1141.

The processor 1110 may acquire an external input through an input module 1130 or a sensor module 1161 and execute an application corresponding to the external input. For example, when a user selects a camera icon (or a camera application icon) displayed on the display panel 1141, the processor 1110 may acquire a user input through an input sensor 1161-2 and activate a camera module 1171. The processor 1110 may transmit image data corresponding to a captured image acquired through the camera module 1171 to the display module 1140. The display module 1140 may display an image corresponding to the captured image through the display panel 1141.

As another example, when personal information authentication is executed in the display module 1140, a fingerprint sensor 1161-1 may acquire input fingerprint information as input data. The processor 1110 may compare the input data acquired through the fingerprint sensor 1161-1 with authentication data stored in the memory 1120, and execute an application based on the comparison result. The display module 1140 may display information executed according to the logic of the application through the display panel 1141. The fingerprint sensor 1161-1 may be configured or arranged to acquire fingerprint information from an entire area of the display module 1140 (or the display panel 1141).

As still another example, when a music streaming icon displayed on the display module 1140 is selected, the processor 1110 may acquire a user input through the input sensor 1161-2 and activate a music streaming application stored in the memory 1120. When a music execution command is input in the music streaming application, the processor 1110 may activate an audio output module 1163 to provide the user with audio information corresponding to the music execution command.

In the above, the operation of the electronic device 1000 is briefly described. Below, the configuration of the electronic device 1000 is described in detail. Some of components of the electronic device 1000 described below may be integrated and provided as one component, and one component may be provided by being divided into two or more components.

The electronic device 1000 may communicate with an external electronic device 2000 via a network (for example, a short-range wireless communication network or a long-range wireless communication network). According to some embodiments, the electronic device 1000 may include the processor 1110, the memory 1120, the input module 1130, the display module 1140, a power source module 1150, a built-in module 1160, and an external module 1170. According to some embodiments, in the electronic device 1000, at least one of the above-described components may be omitted, or one or more other components may be added. According to some embodiments, some of the above-described components (for example, the sensor module 1161, an antenna module 1162, or the audio output module 1163) may be integrated into another component (for example, the display module 1140).

The processor 1110 may execute software to control at least one other component (for example, a hardware or software component) of the electronic device 1000 connected to the processor 1110 and perform various data processing or calculations. According to some embodiments, as at least part of data processing or calculations, the processor 1110 may store commands or data received from another component (for example, the input module 1130, the sensor module 1161, or a communication module 1173) in a volatile memory 1121, process the commands or data stored in the volatile memory 1121, and store resulting data in a non-volatile memory 1122.

The processor 1110 may include a main processor 1111 and a coprocessor 1112. The main processor 1111 may include one or more of a central processing unit (CPU) 1111-1 and an application processor (AP). The main processor 1111 may further include one or more of a graphics processing unit (GPU) 1111-2, a communication processor (CP), and an image signal processor (ISP). The main processor 1111 may further include a neural network processing unit (NPU) 1111-3.

The neural network processing unit 1111-3 may be a processor specialized in processing artificial intelligence models, and the artificial intelligence models may be generated through machine learning. The artificial intelligence models may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, and a combination of two or more of the above, but the present invention is not limited to the examples described above. In addition to the hardware structure, the artificial intelligence model may additionally or alternatively include a software structure. At least two of the processing units and processors described above may be implemented as a single integrated component (for example, a single chip), or each may be implemented as an independent component (for example, a plurality of chips).

The coprocessor 1112 may include a controller 1112-1. The controller 1112-1 may include an interface conversion circuit and a timing control circuit. As an example, the controller 1112-1 may include the timing controller 120 shown in FIG. 1. The controller 1112-1 may receive an image signal from the main processor 1111, convert the data format of the image signal to match the interface specifications with the display module 1140, and output image data. The controller 1112-1 may output various control signals required to drive the display module 1140.

The coprocessor 1112 may further include a data conversion circuit 1112-2, a gamma correction circuit 1112-3, a rendering circuit 1112-4, a touch control circuit, and the like. The data conversion circuit 1112-2 may receive the image data from the controller 1112-1 and may compensate for the image data so that an image is displayed at a desired luminance according to the characteristics of the electronic device 1000 or the user's settings, or convert the image data to reduce power consumption or compensate for afterimages.

As an example, the data conversion circuit 1112-2 may include the deterioration compensator 200 shown in FIG. 1. The data conversion circuit 1112-2 may generate the accumulated deterioration data AAge and generate the correction data CDATA corresponding to the accumulated deterioration data AAge.

The gamma correction circuit 1112-3 may convert the image data, a gamma reference voltage, or the like so that the image displayed on the electronic device 1000 has the desired gamma characteristics. The rendering circuit 1112-4 may receive the image data from the controller 1112-1 and render the image data by considering the pixel layout of the display panel 1141 applied to the electronic device 1000.

The touch control circuit may supply a touch signal to the input sensor 1161-2 and receive a sensing signal from the input sensor 1161-2 in response to the touch signal.

At least one of the data conversion circuit 1112-2, the gamma correction circuit 1112-3, the rendering circuit 1112-4, or the touch control circuit may be integrated into another component (for example, the main processor 1111 or the controller 1112-1). At least one of the data conversion circuit 1112-2, the gamma correction circuit 1112-3, or the rendering circuit 1112-4 may also be integrated into a source driver 1143 described below.

The memory 1120 may store various data used by at least one component (for example, the processor 1110 or the sensor module 1161) of the electronic device 1000 and input data or output data for commands related thereto. In addition, various setting data corresponding to the user's settings may be stored in the memory 1120. The memory 1120 may include at least one of the volatile memory 1121 or the non-volatile memory 1122. The memory 1120 may include the memory 300 shown in FIG. 1.

The input module 1130 may receive commands or data to be used in components of the electronic device 1000 (for example, the processor 1110, the sensor module 1161, or the audio output module 1163) from outside (for example, the user or the external electronic device 2000) the electronic device 1000.

The input module 1130 may include a first input module 1131 into which commands or data are input from the user, and a second input module 1132 into which commands or data are input from the external electronic device 2000. The first input module 1131 may include a microphone, a mouse, a keyboard, a key (for example, a button), or a pen (for example, a passive pen or an active pen). The second input module 1132 may support a designated protocol that can be connected to the external electronic device 2000 via wired or wireless means. According to some embodiments, the second input module 1132 may include a high definition multimedia interface (HDMI), a universal serial bus (USB) interface, an SD card interface, or an audio interface. The second input module 1132 may include a connector that can be physically connected to the external electronic device 2000, for example, an HDMI connector, a USB connector, an SD card connector, or an audio connector (for example, a headphone connector).

The display module 1140 may provide visual information to the user. The display module 1140 may include the display panel 1141, a gate driver 1142, and the source driver 1143. The display module 1140 may further include a window, a chassis, and a bracket to protect the display panel 1141.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141.

The display panel 1141 may receive the image data from the coprocessor 1112 and display an image while controlling the amount of current supplied from the first driving power source VDD to the second driving power source VSS via the pixels PX in response to the image data. The display panel 1141 may correspond to the display unit 110 shown in FIG. 1.

The gate driver 1142 may be mounted on the display panel 1141 as a driving chip. In addition, the gate driver 1142 may be integrated into the display panel 1141.

For example, the gate driver 1142 may include an ASG (Amorphous Silicon TFT Gate driver circuit), an LTPS (Low Temperature Polycrystalline Silicon) TFT Gate driver circuit, or an OSG (Oxide Semiconductor TFT Gate driver circuit) embedded in the display panel 1141. The gate driver 1142 may receive a control signal from the controller 1112-1 and output scan signals to the display panel 1141 in response to the control signal. The gate driver 1142 may include the scan driver 130 shown in FIG. 1.

The display module 1140 may further include an emission driver. The emission driver may output an emission control signal to the display panel 1141 in response to a control signal received from the controller 1112-1. The emission driver may be formed separately from the gate driver 1142 or may be integrated into the gate driver 1142.

The source driver 1143 may receive a control signal from the controller 1112-1, convert the image data into an analog voltage (for example, a data signal) in response to the control signal, and then output data signals to the display panel 1141. The source driver 1143 may include the data driver 140 shown in FIG. 1.

The source driver 1143 may be integrated into another component (for example, the controller 1112-1). The functions of the interface conversion circuit and the timing control circuit of the controller 1112-1 described above may also be integrated into the source driver 1143.

The display module 1140 may further include a voltage generation circuit 1144. The voltage generation circuit 1144 may output various voltages required to drive the display panel 1141. As an example, the voltage generation circuit 1144 may generate the first driving power source VDD, the second driving power source VSS, and the initialization power source VINT.

According to some embodiments, the display panel 1141 may include a plurality of pixel columns, each of which includes a plurality of pixels.

According to some embodiments, the source driver 1143 may convert data corresponding to red (R), green (G), and blue (B) included in the image data received from the processor 1110 into a red data signal (or data voltage), a green data signal, and a blue data signal, and provide them to a plurality of pixel rows included in the display panel 1141 during one horizontal period.

The power source module 1150 may supply power to the components of the electronic device 1000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the modules described above and the modules described below. The power source module 1150 may include a wireless power transceiver member electrically connected to the battery. The wireless power transceiver member may include a plurality of coil-shaped antenna radiators. The voltage generation circuit 1144 may be integrated with the power source module 1150.

The electronic device 1000 may further include a built-in module 1160 and an external module 1170. The built-in module 1160 may include the sensor module 1161, the antenna module 1162, and the audio output module 1163. The external module 1170 may include the camera module 1171, a light module 1172, and the communication module 1173.

The sensor module 1161 may detect an input by a user's body or an input by the pen of the first input module 1131, and generate an electric signal or data value corresponding to the input. The sensor module 1161 may include at least one of the fingerprint sensor 1161-1, the input sensor 1161-2, or a digitizer 1161-3.

The fingerprint sensor 1161-1 may generate a data value corresponding to a user's fingerprint. The fingerprint sensor 1161-1 may include any one of an optical fingerprint sensor and a capacitive fingerprint sensor.

The input sensor 1161-2 may generate a data value corresponding to coordinate information of the input by the user's body or the input by the pen. The input sensor 1161-2 may generate the amount of change in capacitance due to the input as the data value. The input sensor 1161-2 may detect an input by a passive pen or transmit and receive data with an active pen.

The input sensor 1161-2 may also measure bio-signals such as blood pressure, moisture, or body fat. For example, when a user touches a part of his or her body to a sensor layer or sensing panel and does not move for a certain period of time, the input sensor 1161-2 may detect a bio-signal based on a change in electric field caused by the part of his or her body and output information desired by the user to the display module 1140.

The digitizer 1161-3 may generate a data value corresponding to coordinate information of the input by the pen. The digitizer 1161-3 may generate the amount of change in electromagnetic due to the input as the data value. The digitizer 1161-3 may detect an input by a passive pen or transmit and receive data with an active pen. At least one of the fingerprint sensor 1161-1, the input sensor 1161-2, or the

digitizer 1161-3 may be implemented as the sensor layer formed on the display panel 1141 through a continuous process. At least one of the fingerprint sensor 1161-1, the input sensor 1161-2, or the digitizer 1161-3 may be located on an upper side of the display panel 1141, and any one of the fingerprint sensor 1161-1, the input sensor 1161-2, and the digitizer 1161-3, for example, the digitizer 1161-3, may be located on a lower side of the display panel 1141.

At least two of the fingerprint sensor 1161-1, the input sensor 1161-2, and the digitizer 1161-3 may be formed to be integrated into one sensing panel through the same process. When integrated into one sensing panel, the sensing panel may be located between the display panel 1141 and a window located on the upper side of the display panel 1141. According to some embodiments, the sensing panel may also be located on the window, and the position of the sensing panel is not particularly limited. At least one of the fingerprint sensor 1161-1, the input sensor 1161-2, or the

digitizer 1161-3 may be built into the display panel 1141. That is, at least one of the fingerprint sensor 1161-1, the input sensor 1161-2, or the digitizer 1161-3 may be formed simultaneously through a process of forming elements (for example, the light emitting element, the transistor, and the like) included in the display panel 1141.

In addition, the sensor module 1161 may generate an electric signal or data value corresponding to an internal state or an external state of the electronic device 1000. The sensor module 1161 may further include, for example, a gesture sensor, a gyro sensor, a pressure sensor, a magnetic sensor, an acceleration sensor, a grip sensor, a proximity sensor, a color sensor, an infrared (IR) sensor, a biometric sensor, a temperature sensor, a humidity sensor, or a light sensor.

The antenna module 1162 may include one or more antennas for transmitting signals or power to the outside or receiving signals from the outside. According to some embodiments, the communication module 1173 may transmit signals to an external electronic device or receive signals from the external electronic device through an antenna suitable for a communication method. An antenna pattern of the antenna module 1162 may be integrated into one component (for example, the display panel 1141) of the display module 1140, the input sensor 1161-2, or the like.

The audio output module 1163 may be a device for outputting an audio signal to the outside of the electronic device 1000, and may include, for example, a speaker used for general purposes such as multimedia playback or recording playback, and a receiver used exclusively for telephone reception. According to some embodiments, the receiver may be formed integrally with or separately from the speaker. An audio output pattern of the audio output module 1163 may also be integrated into the display module 1140.

The camera module 1171 may capture a still image and a moving image. According to some embodiments, the camera module 1171 may include one or more lenses, image sensors, or image signal processors. The camera module 1171 may further include an infrared camera that can measure the presence or absence of a user, the location of a user, the line of sight of a user, and the like.

The light module 1172 may provide light. The light module 1172 may include a light emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and performance of communication through the established communication channel. The communication module 1173 may include one or both of a wireless communication module, such as a cellular communication module, a short-range wireless communication module, or a GNSS (global navigation satellite system) communication module, and a wired communication module, such as a LAN (local area network) communication module or a power line communication module. The communication module 1173 may communicate with the external electronic device 2000 via a short-range communication network such as Bluetooth, WiFi direct, or IrDA (infrared data association), or a long-range communication network such as a cellular network, the Internet, or a computer network (for example, LAN or WAN). The various types of communication modules 1173 described above may be implemented as one chip or as separate chips.

The input module 1130, the sensor module 1161, the camera module 1171, and the like may be used to control the operation of the display module 1140 in conjunction with the processor 1110.

The processor 1110 may output a command or data to the display module 1140, the audio output module 1163, the camera module 1171, or the light module 1172 based on the input data received from the input module 1130. For example, the processor 1110 may generate the image data in response to the input data received through a mouse, an active pen, or the like and output the image data to the display module 1140, or generate command data in response to the input data and output the command data to the camera module 1171 or the light module 1172. When the input data is not received from the input module 1130, the processor 1110 may switch the operation mode of the electronic device 1000 to a low power mode or sleep mode to reduce power consumption of the electronic device 1000.

The processor 1110 may output a command or data to the display module 1140, the audio output module 1163, the camera module 1171, or the light module 1172 based on sensing data received from the sensor module 1161. For example, the processor 1110 may compare authentication data authorized by the fingerprint sensor 1161-1 with the authentication data stored in the memory 1120, and then execute an application based on the comparison result. The processor 1110 may execute a command or output corresponding image data to the display module 1140 based on sensing data detected by the input sensor 1161-2 or the digitizer 1161-3. When a temperature sensor is included in the sensor module 1161, the processor 1110 may receive temperature data on the temperature measured from the sensor module 1161 and further perform luminance correction and the like on the image data based on the temperature data.

The processor 1110 may receive measurement data on the presence or absence of a user, the location of a user, the line of sight of a user, and the like from the camera module 1171. The processor 1110 may further perform luminance correction and the like on the image data based on the measurement data. For example, the processor 1110 that determines the presence or absence of a user based on an input from the camera module 1171 may output image data whose luminance is corrected through the data conversion circuit 1112-2 or the gamma correction circuit 1112-3 to the display module 1140.

Some of the components described above may be interconnected with each other through a communication method between peripheral devices, such as a bus, GPIO (general purpose input/output), SPI (serial peripheral interface), MIPI (mobile industry processor interface), or UPI (ultra path interconnect) link, to exchange signals (for example, commands or data) with each other. The processor 1110 may communicate with the display module 1140 through a mutually agreed upon interface. For example, any one of the above-described communication methods may be used, and is not limited to the above-described communication methods.

According to the display device, the method of driving the same, and the electronic device according to the embodiments of the present invention, the accuracy of deterioration compensation can be relatively improved by generating the accumulated deterioration data by reflecting the efficiency weight corresponding to each grayscale.

However, effects of the present invention are not limited to the above-

described effects, and may be variously extended without departing from the spirit and scope of the present invention.

As described above, aspects of some embodiments of the present invention have been described with reference to the drawings. However, those skilled in the art will appreciate that various modifications and changes can be made to the present invention without departing from the spirit and scope of the invention as set forth in the appended claims, and their equivalents.

What is claimed is:

1. A display device comprising:
a display unit including pixels;
a deterioration compensator configured to generate input deterioration data by reflecting weights on input data and configured to generate correction data using accumulated deterioration data generated by accumulating the input deterioration data; and
a timing controller configured to generate output data by reflecting the correction data to the input data,
wherein the weights include an efficiency weight, and the efficiency weight corresponds to efficiency of the pixels corresponding to each of grayscales.

2. The display device of claim 1, wherein the efficiency weight is set so that a difference in driving current flowing through each of the pixels corresponding to each of the grayscales is reflected in the input deterioration data.

3. The display device of claim 1, wherein the efficiency weight is stored in the deterioration compensator in units of pixels corresponding to each of the grayscales.

4. The display device of claim 1, wherein the efficiency weight is stored in the deterioration compensator in units of blocks corresponding to each of the grayscales, and each of the blocks includes at least two pixels.

5. The display device of claim 1, wherein the efficiency weight is stored in the deterioration compensator by averaging the efficiency weight of each of the pixels corresponding to each of the grayscales.

6. The display device of claim 1, wherein the weights further include a position weight corresponding to positions of the pixels and a temperature weight corresponding to a temperature.

7. The display device of claim 6, further comprising:
a memory configured to store the accumulated deterioration data.

8. The display device of claim 7, wherein the deterioration compensator includes:
an efficiency lookup table configured to store the efficiency weight;
a position lookup table configured to store the position weight;
a temperature lookup table configured to store the temperature weight;
a deterioration accumulator configured to generate the input deterioration data by reflecting the efficiency weight, the position weight, and the temperature weight to the input data, accumulating the input deterioration data, and configured to store the accumulated deterioration data in the memory; and
a data generator configured to generate the correction data using the accumulated deterioration data stored in the memory.

9. The display device of claim 8, wherein the memory is configured to store the efficiency lookup table, the position lookup table, and the temperature lookup table.

10. The display device of claim 1, further comprising:
a scan driver configured to drive scan lines connected to the pixels; and
a data driver configured to drive data lines connected to the pixels, wherein the data driver configured to generate a data signal using the output data, and to supply the data signal to the pixels via the data lines.

11. A method of driving a display device comprising:
generating input deterioration data by reflecting an efficiency weight corresponding to efficiency of pixels corresponding to each of grayscales to input data;
generating accumulated deterioration data by accumulating the input deterioration data;
generating correction data based on the accumulated deterioration data so that deterioration of the pixels can be compensated for; and
generating output data by reflecting the correction data to the input data.

12. The method of claim 11, wherein the efficiency weight is set so that a difference in driving current flowing through each of the pixels corresponding to each of the grayscales is reflected in the input deterioration data.

13. The method of claim 11, wherein the efficiency weight is reflected in the input data in units of pixels corresponding to each of the grayscales.

14. The method of claim 11, wherein the efficiency weight is reflected in the input data in units of blocks corresponding to each of the grayscales, and each of the blocks includes at least two pixels.

15. The method of claim 11, wherein in the generating the input deterioration data, a position weight corresponding to positions of the pixels and a temperature weight corresponding to a temperature are further reflected in the input data.

16. The method of claim 11, further comprising:
generating a data signal using the output data; and
supplying the data signal to the pixels.

17. An electronic device comprising:
a display panel including pixels;
a data conversion circuit configured to generate input deterioration data by reflecting weights on input data and configured to generate correction data using accumulated deterioration data generated by accumulating the input deterioration data; and
a controller configured to generate output data by reflecting the correction data to the input data,
wherein the weights include an efficiency weight, and the efficiency weight reflects efficiency of the pixels corresponding to each of grayscales.

18. The electronic device of claim 17, wherein the efficiency weight is set so that a difference in driving current flowing through each of the pixels corresponding to each of the grayscales is reflected in the input deterioration data.

19. The electronic device of claim 17, wherein the efficiency weight is stored in the data conversion circuit in units of pixels corresponding to each of the grayscales.

20. The electronic device of claim 17, wherein the efficiency weight is stored in the data conversion circuit in units of blocks corresponding to each of the grayscales, and each of the blocks includes at least two pixels.
